(19) United States
(12) Patent Application Publication
(10) Pub. No.: US 2024/0365828 A1
(43) Pub. Date: Nov. 7, 2024

(54) PATATIN AS BINDER IN FOOD PRODUCTS OTHER THAN MEAT SUBSTITUTES

(71) Applicant: COÖPERATIE KONINKLIJKE AVEBE U.A., Veendam (NL)

(72) Inventors: Robin Eric Jacobus SPELBRINK, Scharmer (NL); Christina Lamberta Catharina SEEGERS, Groningen (NL); Nikola STANISIC, Groningen (NL); Zhenghong CHEN, Groningen (NL)

(21) Appl. No.: 18/292,477

(22) PCT Filed: Jul. 28, 2022
(86) PCT No.: PCT/NL2022/050449

§ 371 Date: Jan. 26, 2024

(30) Foreign Application Priority Data
Jul. 29, 2021 (WO) PCT/NL2021/050481
Dec. 23, 2021 (EP) 21217542.6

(51) Int. Cl. A23L 29/244; A21D 2/16; A21D 2/26; A23D 7/005; A23J 3/14; A23L 15/00; A23L 23/00

(52) U.S. Cl. CPC A23L 29/244; A21D 2/165; A21D 2/264; A23D 7/0053; A23J 3/14; A23L 15/20; A23L 15/35; A23L 23/00

(57) ABSTRACT

The invention provides a method for suppressing off-flavor formation in food products other than meat substitutes which comprise or have been prepared from a mixture comprising water, a lipid and native patatin, as well as to food products thus obtained.

### BACKGROUND

Native patatin can be used in food products for various reasons, including as a gelling agent or emulsifier. In food products which furthermore comprise a lipid, and in which native patatin is in contact with the lipid, use of native patatin may under certain conditions cause the formation of off-flavors.

Patatin has been known to hydrolyze phospholipids and monoglycerides, but does not generally have hydrolytic activity on triglycerides (see for instance Hirschberg et al, Eur. J. Biochem 2001, 268, 5037, Galliard et al., Biochem. J. 1971, 121, 379 or Andrews et al, Biochem J. 1988, 252, 199). Patatin has however been described as having specific but low activity against triglycerides with short chain fatty acids, which is advantageous for the development of cheese flavor (WO 2014/007621). However, most common plant-based lipids do not comprise such short-chain fatty acids. In fact, most plant based lipids generally comprises only fatty acids having a chain length of C8 or longer. Thus, prior to the presently formulated insights, it has not been recognized that patatin may cause hydrolysis of lipids with medium to long chain fatty acids to a significant extent.

Bakery products, in particular vegan bakery products, may be based on a dough or batter which comprises native patatin. This dough or batter in general furthermore comprises a lipid. In such products, native patatin has the function of binding the dough or foaming the batter before and during the baking process, and stabilizing the emulsion. Although during baking, the patatin denatures, the obtained bakery product still benefits from the presence of the denatured protein, as it binds the bakery product to a solid palatable food product to provide the sponge structure and elastic texture. During the preparation of the dough or batter, as well as during baking however, the presence of native patatin may cause the generation of off-flavors, a drawback which has not formerly been recognized.

The present invention is based on the insight that native patatin may cause off-flavors when it is present in the presence of particular types of lipid. The invention provides methods for preparing food products other than meat substitutes, which food products are based on mixtures comprising water, native patatin and particular types of lipid, which lipid selection suppresses the formation of off-flavors.

### The Invention

The inventors found that the use of native patatin as a binder in lipid-containing food products other than meat substitutes results in formation of off-flavors at any time that a lipid is in contact with native patatin, and that off-flavor formation occurs faster at higher temperatures (as long as patatin does not denature).

Thus, off-flavor formation may occur during preparation, storage, and in the first stages of baking, for any food product which comprises or is prepared from native patatin.

For the sake of clarity and concise description, food products which are prepared from native patatin, but in which the patatin fully or partially denatures during preparation, such as by heating, can be described as food products comprising native patatin. This is in line with the common general knowledge of the skilled person who describes food products by the ingredients which are used to prepare the said food product, rather than by the state of the separate ingredients after preparation.

Alternatively, food products in which the patatin fully or partially denatures during preparation can be described as having been prepared from native patatin. In this alternative, the actual preparation method provides the food product, and thereby also provides the features of the said food product imparted by the preparation method.

The inventors found that off-flavor formation can be prevented by preparing the food product using only particular types of lipid. This results in food products with decreased off-flavors and/or a long shelf-life, such as up to 14 days, or longer (if frozen).

In the present context, the food product can be any food product other than a meat substitute. Thus the food product is not a meat substitute; the food product can be any food product except for a meat substitute. The meat substitute is defined elsewhere; hereafter, the wording “food product” excludes meat substitutes, throughout, except where clearly intended otherwise.

A meat substitute, in the present context, is a product which resembles animal-derived meat, but which is prepared using mainly plant-based ingredients. A meat substitute is thus suitable for vegetarians, and may depending on the actual ingredients used, also be suitable for a vegan lifestyle.

The invention thus provides a method for making a food product other than a meat substitute, comprising
a) providing a mixture comprising water, native patatin and a lipid, which lipid is defined as a substance comprising fatty acid tri-esters of glycerol, wherein the fatty acids in said lipid comprise less than 2% by mass of fatty acids having a chain length of C12 or less, and wherein the quantity of lipid relative to native patatin, expressed as the weight ratio of lipid to native patatin, is 90:1 or less;
b) making the food product.

Native patatin is a protein which occurs in tubers, such as tubers of potato (Solanum tuberosum). The skilled person is aware which of the protein in a tuber can be considered patatin.

Patatin is a protein which is naturally present in the tuber as storage protein. Storage protein is protein which functions as a store for nitrogen, sulphur and/or carbon, enabling the plant to survive periods of adverse growth conditions or between growing seasons. Storage protein is generally present in a quantity of 40-50 wt. % of all protein in the tuber. Storage protein can generally be characterized by a molecular weight of 35-50 kDa, preferably 38-45 kDa and/or by an isoelectric point of 4.8-5.6. The molecular weight can be determined by commonly known methods, such as SDS page. The isoelectric point can also be determined by commonly known methods, such as for example isoelectric focusing.

In the present context, native patatin is preferably provided to the mixture in the form of a protein isolate comprising native patatin. In a preferred embodiment, the protein isolate comprising native patatin is a native tuber protein isolate, preferably a native potato protein isolate. In said native tuber protein isolate, protein is preferably present in a quantity of at least 75 wt. %, preferably at least 85 wt. %, relative to dry matter.

In preferred embodiments, the native tuber protein isolate, such as the native potato protein isolate, comprises, by wt. % of total protein, at least 35 wt. % of potato storage protein, preferably at least 40 wt. %. In embodiments where there is from 35 up to 60 wt. % of potato storage protein (patatin), relative to total protein, the tuber protein isolate can be called a total tuber protein isolate.

In further preferred embodiments, the native tuber protein isolate, such as the native potato protein isolate, comprises, by wt. % of total protein, at least 75 wt. % of potato storage protein (patatin), preferably at least 80 wt. %. In embodiments where there is 60 wt. % or more up to 85 wt. % of potato storage protein (patatin), relative to total protein, the tuber protein isolate can be called a HMW isolate comprising patatin.

In further preferred embodiments, the native tuber protein isolate, such as the native potato protein isolate, comprises, by wt. % of total protein, at least 90 wt. %, more preferably at least 95 wt. % of potato storage protein (patatin). In embodiments where there is 90 wt. % or more up to and including 100 wt. % of potato storage protein (patatin), relative to total protein, the tuber protein isolate can be called a patatin isolate. An example of a patatin isolate is Solanic 200 from Avebe.

Native patatin can be isolated from potato tubers, or from other potato-derived processing streams such as potato juice (for example the juice obtained as a side product in potato starch manufacturing), or potato cutting water (the processing water which is obtained when potatoes are being shaped for consumption as for example fries or chips). One particularly convenient method to isolate native patatin has been described in WO2008/069650, although the skilled person can obtain native patatin by other methods. In addition, native patatin is commercially available.

In further preferred embodiments, native patatin is used in the state in which it occurs in nature. That is, native patatin is preferably not modified, such as by crosslinking or complexation. As is generally known by the skilled person, native patatin is by definition a non-denatured protein; that is, native patatin is patatin which is capable of performing its natural biochemical function(s). Native patatin thus is not appreciably denatured, and has not been subjected to for example coagulation, such as heat coagulation or acid coagulation.

Native patatin can be present in the mixture at any quantity, such as from 0.1-25 wt. %, preferably 0.5-20 wt. %, more preferably 0.75-15 wt. %. Higher quantities of native patatin, as well as higher temperatures, result in higher off-flavor formation, which off-flavor formation can be suppressed or eliminated by applying a lipid as defined herein.

Water, also can be present in any quantity, such as in a quantity of 5-95 wt. %, preferably 10-90 wt. %, more preferably 15-85 wt. %. The quantity of water varies with the type of food product being prepared, as is well known in the art.

The lipid to be included in the mixture is defined as a substance comprising fatty acid tri-esters of glycerol, as is known in the art. A fatty acid tri-ester of glycerol is also known as a triacyl glyceride (TAG), or as a triglyceride. Although the term lipid may sometimes be used to include various other glycerol esters, such as phospholipids or glycolipids, the term lipid in the present context is limited to fatty acid tri-esters of glycerol, that is, molecules based on glycerol which are esterified with fatty acids on all three hydroxyl units of the glycerol moiety.

The fatty acids in said lipid comprise less than 2% by mass, preferably less than 1.5% by mass, more preferably less than 1% by mass, even more preferably less than 0.5% by mass, of fatty acids having a chain length of C12 or less.

In preferred embodiments, the fatty acids comprise less than 2% by mass, preferably less than 1.5% by mass, more preferably less than 1% by mass, even more preferably less than 0.5% by mass of fatty acids having a chain length of C14 or less.

In further preferred embodiments, the fatty acids comprise less than 30% by mass, preferably less than 25% by mass, more preferably less than 20% by mass, even more preferably less than 15% by mass of fatty acids having a chain length of C16 or less.

In further preferred embodiments, the lipid is a substance wherein at least 92% by mass, preferably at least 94% by mass, more preferably at least 96% by mass of the fatty acids are fatty acids having a chain length of C16 or higher.

In further preferred embodiments, the lipid is a substance wherein the total of C10-C16 fatty acids is less than 35% by mass, preferably less than 25% by mass, even more preferably 18% by mass, relative to the total fatty acids.

Native patatin, has been found to have at least some activity on some lipids comprising fatty acids with a chain length of C10 or higher, at least to a sufficient extent to cause off-flavors. This activity is also present on some lipids comprising fatty acids with a chain length of C12 or higher, and even on some lipids comprising fatty acids with a chain length of C14 or higher. Even lipids comprising fatty acids with a chain length of C16 or higher can be hydrolyzed by patatin to a degree which is sufficient to cause off-flavors.

It is thus an insight underlying the invention that patatin exerts activity on triglycerides with chain lengths of from C8 to C16, to such an extent that this activity causes off-flavors.

The action of patatin may be hydrolytic, but may also be another, yet unknown enzymatic activity of patatin, which activity is suppressed by applying a lipid as defined in claim 1 and elsewhere. The exact mechanism behind off-flavor formation in food products comprising native patatin but using a different lipid than in claim 1 is at present not understood. The examples show however that formulating a food product in line with the present invention suppresses off-flavor formation.

Off-flavors in the present context are defined as a lingering bitter sensation upon ingestion, which is accompanied by a stingy smell that can be described as “paint” or “vomit”. The lipids recited in claim 1 and elsewhere can be used to avoid off-flavor formation.

Off-flavor can preferably be determined by sensory evaluation. Off flavor can also be determined in model systems by measuring the release of free fatty acids and/or by measuring the para-anisidine value. In such cases, off-flavor can be defined as not present provided that the pAV of the lipid is maintained at 2 or less, preferably 1.5 or less, even more preferably 1 or less, and/or provided that the release of free fatty acids from the lipid is less than 50 mmol/kg oil, preferably less than 40 mmol./kg oil.

Much preferred lipids are plant-based lipids, such as a seed oil, nut oil, or fruit oil. Mixtures of different lipids may also be used. Particularly preferred lipids comprise one or more of the lipids in the group of corn oil, soybean oil, rapeseed oil, sunflower oil, grape seed oil, peanut oil, sesame oil, olive oil, shea butter, cocoa butter, and rice bran oil. In optional embodiments, the lipid may be partially hydrogenated. In some embodiments, the lipid does not comprise rapeseed oil.

The lipid may colloquially be referred to as a fat or an oil. An oil in the present context is a lipid which is liquid or viscous at 20° C. (under atmospheric pressure). Liquid or viscous is a term which reflects the capability to flow under the influence of gravity.

Fat in the present context is a lipid which is solid at room temperature (20° C.) (under atmospheric pressure). Solid in this context is defined as the capability to maintain a particular shape for at least 24 hours in the absence of support. If pressure is applied above atmospheric pressure, a solid lipid may change shape, which changed shape can be maintained for at least 24 hours after the pressure has been applied, without support.

The lipid to be provided to the mixture is preferably as pure as possible. That is, the quantity of free fatty acids (“FFA”) in the lipid is preferably less than 18 mmol per kg lipid, more preferably less than 9 mmol per kg lipid, even more preferably less than 3 mmol per kg lipid. The quantity of free fatty acids in the lipid can be determined by a chemical titration method, as described below. The quantity of free fatty acids can also be determined by HPLC, as is generally known in the art.

Additionally or alternatively, the total quantity of diacylglycerols (“DAG”) and monoacylglycerols (“MAG”) in the lipid to be provided to the mixture is preferably less than 10 wt. %, more preferably less than 6 wt. %, even more preferably less than 4 wt. %, relative to the total lipid. The quantity of DAG and MAG in the lipid can be determined by column chromatography or capillary gas chromatography as described in “Standard Methods for the Analysis of Oils, Fats and Derivatives”, 1^{st} supplement to the 7^{th} edition (IUPAC, 1987).

Food products which may be made using the present invention include any food product which comprises, or has been prepared from, a mixture comprising water, native patatin and a lipid as elsewhere defined.

In the present context, two types of food product may be distinguished, on the basis of the mechanisms by which off-flavors develop: food products which develop off-flavors due to a prolonged period in which native patatin is in contact with the lipid (“cold storage” type food product), and food products which develop off-flavors due to a brief heat shock in which native patatin is in contact with the lipid (“heat shock” type food products).

In cold storage type food products, the prolonged period in which native patatin is in contact with the lipid is generally a storage period, preferably cold storage. Storage includes any prolonged period in which no active steps are taken on the food product. Storage thus means that the food product is left to stand, for any reason, including one or more of storage prior to sale or transport, a period of gelation, or a period of ripening, maturing or fermenting.

Cold storage type food products are food products where making the food product comprises a step of cooling to a temperature of from −35° C. to 20° C. In preferred embodiments, a cold storage type food product has not been heated to a temperature above 60° C. prior to cooling.

Cold storage type food products are food products comprising water, native patatin and a lipid, in which the native patatin is in contact with the lipid during a period of storage, wherein during the period of storage, the patatin is native, thereby having the potential to cause off-flavor formation, which off-flavor formation is suppressed by selecting a lipid according to the present invention.

In preferred cold storage type food products, the native patatin is present as a gelling agent in the mixture. In such cases, the temperature during storage is preferably 0-20° C., more preferably 0° C. to 10° C., even more preferably 0-5° C.

Examples of cold storage type food products are a batter, dough, cheese, cream cheese, butter, yoghurt, sauce, such as a dressing or a mayonnaise, and cream, most preferably a plant-based (vegan) batter, dough, cheese, cream cheese, butter, yoghurt, sauce (such as a dressing or mayonnaise) or cream.

Heat shock type food products are food products where making the food product comprises a step of heating the food product to a temperature of at least 75° C., preferably at least 125° C., more preferably at least 150° C. for a period of at least 1 minute, preferably at least 15 minutes. Heat shock type food products are food products which are prepared from a mixture of water, native patatin and a lipid, in which the native patatin is in contact with the lipid, and in which the rise in temperature during heating causes off-flavor formation prior to denaturation and concomitant inactivation of the patatin.

Examples of heat shock type food products are generally bakery products, such as a muffin, cookie, cake, pie, macaron, sponge cake or waffle. A further preferred heat shock type food product is a fried snack (a product with a crust and an inner filling, which is generally prepared by heating to a temperature of 150-200° C. in fat or oil), such as a croquette, nugget, fish finger or lumpia, most preferably a plant-based (vegan) fried snack.

“Cold storage” type and “heat-shock” type food products are not necessarily mutually exclusive: in some food products, both mechanisms for off-flavor formation are relevant. A dough which is ripened for a few hours to a few days at room temperature may be subsequently baked. In this case, the baked dough may suffer off-flavor formation by both mechanisms, if the lipid used was not a lipid according to the invention. A bakery product is therefore a much preferred embodiment of the invention. Similarly, a batter, such as a vegan egg batter (“scrambled eggs batter”), may be stored cold for a period of time prior to preparing the vegan scrambled eggs. In this case also, both mechanisms for off-flavor formation occur, and such batters, and products stemming from subsequent preparation, are also much preferred embodiments of the invention.

Generally however, cold storage type food products can be distinguished from heat shock type food products, by identification of the main mechanism responsible for off-flavor formation in the food product, in cases where no lipid of the invention is applied.

Bakery products such as muffins are considered primarily heat-shock type food products, because there is relatively little off-flavor formation during the brief period of batter preparation prior to baking, and off-flavor formation occurs more readily during the baking period.

In preferred embodiments, a food product of the invention is a vegetarian or vegan food product, preferably a vegan food product. This has the advantage that the lipids introduced during the making of the food product can be controlled. This is because during the making of a vegan food product, lipids are generally introduced in the form of an isolated and/or purified plant-based lipid, which generally has a well-known composition. For food products comprising meat, fish or crustaceans, the meat, fish or crustacean contributes lipids, the composition of which may be less known, and/or contribute lipids not according to the invention.

Food products of the invention can be made by methods generally known for the making of the type of food product in question. Reference is made to common general knowledge on the making of any individual food product described herein.

It has been found that the problem of off-flavor formation occurs in particular for quantities of lipid relative to native patatin of 90:1 or less. The quantity of lipid, relative to native patatin, can be expressed as the weight ratio of lipid to native patatin. Thus, in particular for weight ratios of lipid to native patatin of 90:1 or less, preferably 80:1 or less, more preferably 75:1 or less, more preferably 70:1 or less, even more preferably 60:1 or less, even more preferably of 50:1 or less, use of a lipid of the invention as defined elsewhere when preparing a food product of the invention prevents off-flavor formation.

Generally in food products, the quantity of lipid is higher than the quantity of native patatin. However, in some food products, the quantity of native patatin may be higher than the quantity of lipid. It is preferred that the minimum weight ratio of lipid to native patatin is 1:10, preferably 1:5, more preferably 1:1. Each of these lower limits for the weight ratio of lipid to native patatin may be combined with the upper limits in the preceding paragraph.

Thus, in food products of the invention, the weight ratio lipid:native patatin is for example preferably 1:1-90:1, more preferably 1:1-80:1, more preferably 1:1-75:1, more preferably 1:1-70:1, more preferably 1:1-60:1, more preferably 1:1-50:1, more preferably 1:1-40:1, more preferably 1:1-25:1. In some embodiments, the weight ratio lipid:native patatin is preferably 1:1-5:1, more preferably 1:1-3:1. The remainder of the mixture is water and optional further ingredients, as outlined elsewhere.

Making the food product preferably comprises one or more of the steps of shaping, mixing, cooling, heating, fermentation, combination with further ingredients and/or a period of storage, preferably cold storage at a temperature of less than 15° C., preferably less than 10° C. This is generally known in the art.

In some food products, the preparation method results in partial or full denaturation of the native patatin. In such food products, the weight ratio of lipid:native patatin refers to the weight ratio of lipid to native patatin used when preparing the food product, prior to the step in which the patatin denatures. For a food product as prepared, this weight ratio may alternatively be called the weight ratio of lipid to patatin.

### Vegan Egg Product

In one embodiment, the invention provides a method for making a vegan egg product. A vegan egg product is a food product which has the appearance and structure of egg as it is normally consumed, but which is fully plant based. Preferred types of vegan egg products are vegan scrambled eggs, or a vegan omelet.

A method of the invention for preparing a vegan egg product comprises providing a mixture comprising water, native patatin, the lipid and optional further ingredients, homogenizing and optionally aerating said mixture to obtain a batter, and heating said batter to a temperature of at least 75° C. for at least one minute, wherein the fatty acids in said lipid comprise less than 2% by mass of fatty acids having a chain length of C12 or less. Reference is made to the further description of the lipid and the native patatin which may be used in the present invention, elsewhere.

The mixture comprising water, native patatin, and the lipid is first mixed to obtain a batter. Mixing may be done by any means known in the art. Mixing which provides a degree of aeration is preferred, such as whipping. The mixture preferably comprises, as wt. % of the mixture,
55-85 wt. %, preferably 60-75 wt. % of water; and
3-15 wt. %, preferably 5-15 wt. % of lipid; and
1-15 wt. % native patatin, preferably 2-10 wt. %, preferably in the form of a native patatin isolate,
Optionally one or more further optional ingredients as defined elsewhere, in a quantity of at most 5 wt. % per ingredient, preferably at most 2 wt. % per ingredient. Egg flavor is preferred.

The mixing provides a batter. The batter is liquid, meaning it is pourable and/or free-flowing.

The batter is subsequently heated to a temperature of at least 75° C., preferably at least 100° C. more preferably at least 125° C., for at least one minute, preferably at least 2 minutes. Preferred means of heating include baking or frying, such as in a frying pan. Reference is made to the art of cooking, in particular to the skilled person's common general knowledge regarding preparation of scrambled eggs or omelet.

The vegan egg product preferably comprises, as optional further ingredients, at least one of
one or more proteins derived from tuber, cereal, nut or legume, preferably soy protein, pea protein, wheat protein/gluten, potato protein, faba bean protein, mungbean protein, hemp seed protein, mushroom protein, sesame seed protein, sweet potato protein, chick pea protein, lentil protein, oat protein and spelt protein, pumpkin seed protein, preferably in a quantity of 1-5 wt. %;
one or more starches derived from tuber, cereal or legume, preferably potato starch, tapioca, rice starch, corn starch, wheat starch or pea starch, said starch most preferably being a granular starch or a pregelatinized starch, and/or preferably being present in a quantity of 1-10 wt. %, preferably 2-8 wt. %;
one or more salts, preferably sodium chloride or potassium chloride, said one or more salts preferably being present in a quantity of 0.2-5 wt. %, preferably 0.5-2 wt. %;
one or more additives, preferably flavorings, colorings or texturisers, including flour, preferably wheat flour, maize flour, tapioca flour, soy flour, rice flour, bean flour, pea flour, potato flour, oat flour, millet flour, sorghum flour, preferably wheat flour or maize flour.

In further preferred embodiments, the vegan egg product may comprise additional ingredients which additional ingredients are preferably vegan, such as one or more of a fruit, vegetable, nut or tuber. Preferred examples include paprika, tomato, garlic, onion, potato, walnut, peanut, and the like.

The optional further ingredients can be added to the mixture prior to preparing the batter, directly to the batter, or during or after heating the batter. Reference is made to common general knowledge on the preparation of egg products.

In further preferred embodiments, the vegan egg product is a vegan pancake. In this embodiment, the batter further comprises flour in a quantity of 5-50, preferably 10-45 wt. %, and at least one type of additional protein, preferably in a quantity of 0.5-5 wt. %, preferably 1-4 wt. %. The batter is subsequently heated to provide a pancake. A vegan pancake, in the present context, may alternatively be referred to as a vegan bakery product.

The invention thus similarly provides a vegan egg product, preferably a batter for an omelet or vegan “scrambled eggs”, comprising, as wt. % of the batter for the vegan egg product,
55-85 wt. %, preferably 60-75 wt. % of water; and
3-15 wt. %, preferably 5-15 wt. % of lipid; and
1-15 wt. % native patatin, preferably 2-10 wt. %, wherein the lipid and the patatin is as defined elsewhere.

The vegan egg product, preferably the omelet or vegan “scrambled eggs”, is prepared from the batter described above, and comprises
55-85 wt. %, preferably 60-75 wt. % of water; and
3-15 wt. %, preferably 5-15 wt. % of lipid; and
1-15 wt. % patatin, preferably 2-10 wt. %, wherein the lipid and the patatin is as defined elsewhere.

Said vegan egg product and/or said vegan egg product batter further preferably comprises at least one of
one or more proteins derived from tuber, cereal, nut or legume, preferably soy protein, pea protein, wheat protein/gluten, potato protein, faba bean protein, mungbean protein, hemp seed protein, mushroom protein, sesame seed protein, sweet potato protein, chick pea protein, lentil protein, oat protein and spelt protein, pumpkin seed protein;
one or more starches derived from tuber, cereal or legume, preferably potato starch, tapioca, rice starch, corn starch, wheat starch or pea starch;
one or more salts, preferably sodium chloride or potassium chloride;
one or more additives, preferably flavorings, colorings or texturisers, including flour;
one or more of a fruit, vegetable, nut or tuber.

### Bakery Products

In another embodiment, the food product is a bakery product. In this embodiment, the method preferably comprises a step of heating the food product to a temperature of at least 75° C., preferably at least 125° C., more preferably at least 150° C. for a period of at least 1 minute, preferably at least 15 minutes. In methods according to the invention in which the food product is a bakery product, the method comprises
a) providing a mixture comprising water, flour, native patatin and the lipid;
b) homogenizing and optionally ripening the mixture; and
c) heating the mixture to a temperature of at least 125° C. for a period of at least 15 minutes.

A bakery product, in the present context, is a food product which comprises at least water, flour, native patatin and the lipid, and further optional well-known ingredients dependent on the type of bakery product in question. Preferred types of bakery products are a muffin, cookie, cake, pie, macaron, sponge cake, or waffle. A pancake, also, may be considered a type of bakery product.

The mixture for preparing the bakery product may comprise water in quantities suitable for the type of bakery product in question. Reference is made to common general knowledge on the preparation of bakery products. If the bakery product is prepared from a batter, the mixture is generally liquid to viscous, and comprises water in a quantity of from 10-40 wt. %, preferably 15-35 wt. %, more preferably 20-30 wt. %. If the bakery product is prepared from a dough, the mixture generally comprises less water, such as from 5-30 wt. %, preferably 10-25 wt. %.

The mixture for making a baking product furthermore comprises flour. Flour can be any type of flour suitable for making the bakery product in question, which is known in the art. Preferred types of flour are wheat flour, maize flour, tapioca flour, soy flour, rice flour, bean flour, pea flour, potato flour, oat flour, millet flour, sorghum flour, preferably wheat flour or maize flour. Flour suitable for making bakery products is commercially available.

The mixture for preparing a bakery product furthermore comprises native patatin. Native patatin suitable for this context has been defined elsewhere. In the making of bakery products as herein defined, patatin denatures during the heating step. Off-flavors however develop at all stages before patatin denaturation, including the periods of active preparation, any cold storage, and the period of baking until denaturation. The invention provides mixtures which suppress this off-flavor formation.

The mixture for preparing a bakery product furthermore comprises a lipid. The lipid, also, has been defined elsewhere. Providing the said lipid to the mixture suppresses off-flavor formation during the heating step.

The mixture for preparing a bakery product furthermore may comprise additional ingredients conventional for the type of bakery product in question. Reference is made to common general knowledge on the making of bakery products.

In preferred embodiments, the mixture may comprise sugar. If sugar is present, sugar may be present in a quantity of from 5-35 wt. %, preferably 10-30 wt. %, more preferably 15-25 wt. %.

In further preferred embodiments, the mixture may comprise yeast. Yeast is particularly suitable in the making of bakery products from a dough, which has preferably been ripened.

In other preferred embodiments, the mixture may comprise a leavening agent. Appropriate leavening agents, and appropriate quantities of use, are generally known in the art. A preferred leavening agent is sodium bicarbonate, which may be present in the mixture a quantity of from 0.1-2 wt. %.

Further conventional ingredients can be salt, such as sodium chloride and/or potassium chloride, which may be present in a quantity of from 0.1-2 wt. %.

Furthermore, the mixture may comprise various known flavorings and additives, as is known in the art. Examples of flavorings include cocoa, vanilla extract, a sweetener, or various fruit, vegetable or meat-like flavorings. Additives may include emulsifiers, stabilizers and/or colorants, as is generally known.

In addition, conventional ingredients may include food items, such as solid food items, among which partitioned or whole fruit, for example partitioned apple pieces, whole or crushed berries or raisins, or partitioned meat, vegetables, chocolate, cheese and the like, as is known in the art. Liquid or viscous food items can also be used, such as milk, butter or cream. Inclusion of food items is particularly preferred in the making of bakery products such as pie, cookies or muffins.

The mixture is subsequently homogenized and optionally ripened, in line with conventional knowledge on the making of bakery products. Homogenization may include mixing, aeration, kneading, whipping, and may be done for any time needed to prepare a suitable dough or batter, such as from 1 minute to 30 minutes.

Ripening may include a period of standing, such as at a temperature of from 0-40° C., preferably 2-36° C. The period may be for example 30 minutes to 300 minutes, as is known in the art.

The step of ripening is preferred for example in cases where the mixture comprises yeast, in which case the temperature during ripening is preferably 20-40° C., more preferably 25-36° C.

The step of ripening is furthermore preferred in cases where the mixture is to gain increased viscosity, such as in cases where the native patatin is present as a gelling agent. In such cases, the temperature during ripening is preferably 0-20° C., more preferably 0° C. to 10° C., even more preferably 0-5° C.

The homogenized and optionally ripened mixture is subsequently baked in order to obtain the bakery product. Baking is achieved by a heating step appropriate for the type of bakery product in question, as is known in the art. Heating is to a temperature of at least 125° C., preferably at least 150° C. more preferably at least 175° C., for a period of at least 15 minutes.

During the heating step, the mixture undergoes several changes conventional in the making of bakery products, and the patatin denatures. Denaturation of patatin occurs at a rate which is slower than the heating of the surface temperature of the bakery product, as the core temperature of the mixture during baking only gradually rises. Generally, the core temperature of the bakery product does not rise above 100° C. during the baking period, so that patatin remains at least partially native to a sufficient extent to result in off-flavor formation, during the majority of the baking period. This off-flavor formation is avoided by selecting a lipid according to the invention.

In much preferred embodiments, the mixture does not comprise animal-derived ingredients. Animal-derived ingredients include for example milk, cream and egg, as is known in the art. In such embodiments, the bakery product is a vegan bakery product, comprising only one or more plant-based lipids.

In further preferred embodiments, the bakery products is a gluten-free bakery product. In such embodiment, ingredients comprising gluten are not present in the final food product. Preferably, a gluten-free bakery product comprises rice flour and/or potato starch, preferably rice flour and potato starch.

One particularly preferred type of bakery product is a muffin. In this embodiment, the mixture is a batter, which batter may comprise of from 10-40 wt. % water, preferably 15-35 wt. %, more preferably 20-30 wt. %. The mixture furthermore comprises flour, preferably wheat flour, in a quantity of from 15-35 wt. %, preferably 20-30 wt. %. The lipid in mixture for making a muffin is present in a quantity of from 15-35 wt. %, preferably 20-30 wt. %.

Bakery products, among which muffins, obtained by the present method include the ingredients listed above for the method, generally in the outlined proportions. However, the mixture is altered by the heating step by various ways in line with common general knowledge, including denaturation of patatin, gelation of flour, decomposition of sodium bicarbonate, and others, resulting in a food product of the invention, obtainable by the methods described above.

The invention furthermore provides a batter or a dough for preparing a bakery product, comprising of from 10-40 wt. % water, preferably 15-35 wt. %, more preferably 20-30 wt. %. The mixture furthermore comprises flour, preferably wheat flour or, for gluten-free products, rice flour, in a quantity of from 15-35 wt. %, preferably 20-30 wt. %. The lipid in the batter or dough is present in a quantity of from 15-35 wt. %, preferably 20-30 wt. %. Native patatin is present in the mixture in a quantity of from 0.1-25 wt. %, preferably 0.5-20 wt. %, more preferably 0.75-15 wt. %. Optionally, the batter or dough comprises 0-35 wt. %, preferably 10-30 wt. %, more preferably 15-25 wt. % of sugar.

### Sauces

In a further embodiment, the food product is a sauce. A sauce in this context may be a dressing, such as a salad dressing, or a gravy or broth. A sauce in the present context is preferably a sauce in the form of an emulsion, preferably an oil-in-water emulsion. Sauces in the form of an emulsion are preferably mayonnaise, Hollandaise sauce, cocktail sauce, garlic sauce, or ravigotte sauce. A much preferred sauce of the invention is mayonnaise.

In methods of the invention wherein the food product is a sauce, the method comprises providing a mixture comprising water, lipid, native patatin and optionally water-dispersible or water-soluble further ingredients, and homogenizing said mixture to obtain the sauce. In preferred embodiments, for a sauce in the form of an emulsion, the method comprises providing a mixture comprising water, native patatin and optionally water-dispersible or water-soluble further ingredients, homogenizing said mixture, and adding lipid while mixing so as to obtain and maintain a stable emulsion.

In methods for preparing sauces according to the invention, native patatin, lipid and water are as defined previously.

For the types and quantities of ingredients for making sauces, as well as to preparation methods for making sauces, reference is made to common general knowledge on the preparation of sauces, in particular emulsion-based sauces. For a sauce, the quantity of oil in the food product can be 20-80 wt. %, based on the total weight of the food product.

In much preferred embodiments, the sauce is a vegan sauce. A vegan sauce does not comprise animal-derived ingredients. Animal-derived ingredients include for example milk, cream and egg, as is known in the art.

A sauce of the invention may comprise, as wt. % of the sauce in question:
15-65 wt. % water, preferably (for regular, “full fat” variants) 15-30 wt. %
0.25-5 wt. % native patatin, preferably 0.5-2.5 wt. %
15-85 wt. % lipid, preferably (for regular, “full fat” variants) 50-85 wt. %

A sauce of the invention may further comprise optional water-dispersible or water soluble optional further ingredients, such as, as wt. % of the sauce in question, maltodextrin in quantity of 0.01-1 wt. %, taste active agents, such as vinegar, mustard, sugar and/or salt, each in a quantity of 0.1-5 wt. %, and/or a stabilizer (e.g. potassium sorbate) in a quantity of 0.01-1 wt. %. Preferably, a preservative is also present.

In some embodiments, a sauce of the invention is a “light” sauce, meaning that the sauce can be described as a low-fat sauce. In such embodiments, part of the lipid (50-75 wt. % of the lipid) may be replaced by e.g. a cold-water soluble starch and (further) water. In such embodiments, the “light” sauce comprises
30-65 wt. % water, preferably 50-65 wt. %
0.25-5 wt. % native patatin, preferably 0.5-2.5 wt. %
15-35 wt. % lipid, preferably 20-30 wt. %
1-10 wt. % cold-water soluble starch.

Suitable starch in this context can be modified starch, such as a crosslinked potato starch, acetylated potato starch, or preferably a crosslinked acetylated potato starch. In much preferred embodiments, the starch is a waxy starch, defined as a starch having an amylopectin content of 90-100 wt. %.

For the purpose of clarity and a concise description features are described herein as part of the same or separate embodiments, however, it will be appreciated that the scope of the invention may include embodiments having combinations of all or some of the features described.

### EXAMPLES

### Chemicals

The patatin used is commercially available (Solanic 200@, Avebe). Potato fiber was Paselli FP from Avebe.

Lipids which are solid at room temperature were 100% pure coconut oil (KTC); 100% red palm oil (Aman Prana); hydrogenated rapeseed oil; commercial vegetable oil A; commercial vegetable oil B, commercial oil palm stearin flakes and commercial shea butter.

Lipids which are liquid or viscous at 20° C. were sunflower oil (Reddy); Olio di Sansa di Oliva (olive oil, Kalliston); corn oil (Olitalia); soybean oil (Levo); grapeseed oil (Saveurs de Lapalisse); rapeseed oil (Your Organic Nature); 100% pure sesame oil (Chee Seng): peanut oil (Heuschen & Schrouff) and rice oil (Alesie).

Texturized vegetable protein in the experiments was texturized soy protein: Soprotex N (Barentz).

### Equipment for Emulsification

When the experiments denote “emulsification”, a T18 Ultraturrax with T18N (10 or 19 g) disperging tool or a T25 Ultraturrax with T25N (8 g) disperging tool from IKA were used. Results with the two types of equipment are identical. In addition, an Analog vortex mixer from VWR was used, and a Multifuge 1S-R or X3R benchtop centrifuge from Thermo Scientific. For weighing, a BP3100 S balance from Satorius was used.

Incubation of Patatin with Lipids and Extraction of the Lipid

A patatin solution was prepared of 3.3% in demineralized water. Solid lipids were melted at 50 or 60° C., except for palm stearin flakes, which were used in solid form. The lipid was added in a 1:1 (w/w) ratio to the patatin solution or to demineralized water, which served as a control. The solutions were mixed by turrax for 1 minute at about 10.000 rpm, except for palm stearin flakes. Then, the solutions were left at room temperature overnight under gently shaking so that release of fatty acids and fat oxidation could occur.

Subsequently hexane was added in a quantity of about 5 ml per 2-gram solution, and the sample was vortexed several times in a time frame of 30 minutes to extract the lipids from the aqueous phase. Subsequently, the layers were separated by centrifugation (5 minutes, 4700 rpm, swing-out). The hexane layer (top layer) was used for determination of free fatty acids and/or pAV. The protocol above was followed unless indicated otherwise.

### Determination of Free Fatty Acid Formation

Patatin cleaves the ester linkage between a fatty acid and the glycerol core, producing free fatty acids. Titrimetry was used to determine the free fatty acid content of mixtures of patatin and a lipid after hexane extraction. The method is based on chemical titration method published by the Cyberlipid Center (Leray).

A solvent mixture (ethanol/tert-Butyl methyl ether, 1/1, v/v) was prepared and 10 ml phenolphthalein solution was added. As titrant a 10 mM KOH in ethanol solution was prepared. The hexane layer of the oil phase was transferred by a glass pipet to a 100 ml Erlenmeyer with cap. Solvent mixture was added to obtain approximately 30-50 ml solution. Titrant was added while stirring the solution on a magnetic stirrer to the end point of the indicator (light purple colour persisting for few seconds). The amount of titrant added was determined by weighting the Erlenmeyer before and after titrant addition. The weight was used to calculate the mmol alkaline/kg of oil was used. The value was corrected for the blank.

$$Equation = \frac{{m}_{titrant} * {M}_{titrant}}{{m}_{oil}} * 1000 = m mol KOH / kg oil$$

in which mₜᵢₜᵣₐₙₜ is mass of titrant added to sample in g, Mₜᵢₜᵣₐₙₜ is the molar mass in mmol KOH/g titrant and mₒᵢₗ is the mass of oil in the sample in g.
Determination of Para-Anisidine Value (pAV) of Lipids

Secondary oxidation products were determined by measuring the para-Anisidine value (pAV) according to the method of the American Oil Chemists Society (AOCS, 2004, Official method Cd. 18-90 in: Official methods and recommended practices of the American Oil Chemists Society). This method detects fatty aldehydes, in particular unsaturated ones. The p-anisidine value is defined as 100 times the optical density measured at 350 nm in a 1 cm cuvette of a solution containing 1.00 g of the oil in 100 mL of a mixture of solvent and para-anisidine reagent (20 mM para-anisidine, SigmaAldrich A88255).

### Determination of Fatty Acid Composition by Gas Chromatography

The fatty acid composition of a lipid was determined by GC, on the basis of full lipid hydrolysis and conversion of the fatty acids to methyl esters.

A lipid sample of about 5 mg was weighed in a 20 ml glass tube, to which there was added 2 ml methanol containing 50M NaOH. The tube was closed, and incubated for 30 min at 70° C. in a block heater. After cooling to room temperature, 3 ml 20% BF₃ reagent in MeOH was added to the tube, effecting methylation of the fatty acids to obtain fatty acid methyl esters (FAME's).

The samples were cooled to room temperature, whereupon 5 ml saturated aqueous NaCl and 2.5 ml n-hexane was added. The tube was closed and vortexed for 1 min and mixed for 15 min with a test tube rotator. From the top hexane layer, there was taken 2 ml, which was transferred to the GC.

| Column | Stabil Wax-Da, 30 m × 0.32 mm, 0.25 μm | |
|---|---|---|
| Oven | 50° C. for 2 min, ramp 16° C./min to 250° C. and | |
| | hold 13 min isotherm at 250° C. | |
| injector | PTV 250° C., flow: 1.2 ml/min, splitless flow: | |
| | 50 ml/min, splitless time: 0.8 min | |
| Run Time | Total run time is 30 min. | |
| Injection volume | 1 μl | |
| MS | Fullscan(TIC) = 30-450 amu, dwell/scan time: 0.2 sec | |
| Retention time | FA_C12:0 10.63 | FA_C18:3 15.32 |
| FAME's (FA) | FA_C14:0 12.03 | FA_C20:0 15.70 |
| (minute) | FA_C16:0 13.29 | FA_C20:1 15.90 |
| | FA_C18:0 14.46 | FA_C22:0 17.39 |
| | FA_C18:1 14.63 | FA_C22:1 17.69 |
| | FA_C18:2 14.91 | FA_C24:0 19.90 |

### Example 1: Determination of the Fatty Acid Composition of Various Lipids

Lipids were purchased as indicated. The fatty acid composition of the lipids was determined following the protocol described above. The results are shown in table 1.

TABLE 1
fatty acid composition of various lipids.

| | oil | | | | | | | |
|---|---|---|---|---|---|---|---|---|
| | | Palm | Red | Palm | Rice | | | |
| | Coconut | kernal | palm | stearin | oil | Corn | Soybean | Grapeseed |
| FA | % (m/m) | % (m/m) | % (m/m) | % (m/m) | % (m/m) | % (m/m) | % (m/m) | % (m/m) |
| C4:0 | ND | ND | ND | ND | ND | ND | ND | ND |
| C6:0 | ND | ND | ND | ND | ND | ND | ND | ND |
| C8:0 | 12.5 | 5.0 | ND | ND | ND | ND | ND | ND |
| C10:0 | 10.5 | 48.0 | ND | ND | ND | ND | ND | ND |
| C12:0 | 29.7 | 16.0 | 1.3 | ND | 0.9 | ND | ND | ND |
| C14:0 | 16.7 | 8.0 | 3.6 | 4.1 | 0.9 | ND | ND | ND |
| C16:0 | 10.4 | 2.0 | 35.8 | 39.6 | 19.4 | 16.9 | 15.0 | 12.8 |
| C18:0 | 5.0 | 15.0 | 8.5 | 13.4 | 4.9 | 4.6 | 6.6 | 9.2 |
| C18:1 | 9.1 | ND | 32.5 | 26.0 | 32.9 | 31.2 | 24.7 | 24.2 |
| C18:2 | 3.7 | ND | 14.0 | 11.0 | 26.9 | 40.1 | 37.4 | 48.7 |
| C18:3 | ND | ND | ND | ND | 2.9 | 2.6 | 11.3 | 1.1 |
| C20:0 | ND | ND | 0.8 | 1.2 | 2.5 | 1.1 | ND | 0.6 |
| C20:1 | ND | ND | ND | ND | 2.3 | 1.0 | ND | 0.9 |
| C22:0 | ND | ND | ND | ND | ND | ND | ND | ND |
| C22:1 | ND | ND | ND | ND | ND | ND | ND | ND |
| C24:0 | ND | ND | ND | ND | 1.1 | ND | ND | ND |
| Rest FA | 2.5 | 6.0 | 3.5 | 4.7 | 5.5 | 2.5 | 5.1 | 2.6 |
| tot ≤C12 | 52.6 | 69.0 | 1.3 | 0.0 | 0.9 | 0.0 | 0.0 | 0.0 |
| tot ≤C14 | 69.4 | 77.0 | 5.0 | 4.1 | 1.8 | 0.0 | 0.0 | 0.0 |
| tot ≤C16 | 79.7 | 79.0 | 40.8 | 43.7 | 21.2 | 16.9 | 15.0 | 12.8 |
| tot ≥C16 | 28.2 | 17.0 | 91.6 | 91.2 | 92.9 | 97.5 | 95.0 | 97.5 |
| tot C10-C16 | 67.3 | 74.0 | 40.8 | 43.7 | 21.2 | 16.9 | 15.0 | 12.8 |
| | oil | | | | | | | |
| | | | | | | shea | Veg | Veg |
| | Sesam | Peanut | Rapeseed | Sunflower | Olive | butter | oil B | oil A |
| FA | % (m/m) | % (m/m) | % (m/m) | % (m/m) | % (m/m) | % (m/m) | % (m/m) | % (m/m) |
| C4:0 | ND | ND | ND | ND | ND | ND | ND | ND |
| C6:0 | ND | ND | ND | ND | ND | ND | ND | ND |
| C8:0 | ND | ND | ND | ND | ND | ND | ND | ND |
| C10:0 | ND | ND | ND | ND | ND | ND | ND | ND |
| C12:0 | ND | ND | ND | ND | ND | ND | ND | 0.6 |
| C14:0 | ND | ND | ND | ND | ND | ND | ND | ND |
| C16:0 | 14.0 | 10.5 | 8.3 | 11.5 | 17.3 | 10.0 | 8.7 | 10.1 |
| C18:0 | 11.8 | 4.8 | 21.1 | 9.0 | 7.7 | 41.4 | 30.2 | 20.0 |
| C18:1 | 33.8 | 42.8 | 27.6 | 32.5 | 46.9 | 32.0 | 40.4 | 50.0 |
| C18:2 | 32.3 | 16.9 | 13.3 | 38.7 | 16.3 | 8.9 | 10.8 | 13.4 |
| C18:3 | 1.3 | 0.8 | 9.5 | ND | 2.4 | ND | ND | ND |
| C20:0 | 2.3 | 2.6 | 3.7 | 0.9 | 1.7 | 4.8 | 3.5 | 1.5 |
| C20:1 | 0.9 | 7.5 | 2.7 | 0.8 | 1.4 | ND | 0.9 | 0.7 |
| C22:0 | ND | 6.2 | 7.0 | 2.5 | 0.6 | ND | 1.9 | ND |
| C22:1 | ND | 1.1 | ND | ND | ND | ND | ND | 1.6 |
| C24:0 | ND | 4.4 | ND | 0.8 | ND | ND | 0.7 | ND |
| Rest FA | 3.7 | 2.8 | 6.9 | 3.4 | 5.7 | 3.0 | 3.1 | 2.2 |
| tot ≤C12 | 0.0 | 0.0 | 0.0 | 0.0 | 0.0 | 0.0 | 0.0 | 0.6 |
| tot ≤C14 | 0.0 | 0.0 | 0.0 | 0.0 | 0.0 | 0.0 | 0.0 | 0.6 |
| tot ≤C16 | 14.0 | 10.5 | 8.3 | 11.5 | 17.3 | 10.0 | 8.7 | 10.7 |
| tot ≥C16 | 96.4 | 97.1 | 93.2 | 96.6 | 94.3 | 97.0 | 96.9 | 97.3 |
| tot C10-C16 | 14.0 | 10.5 | 8.3 | 11.5 | 17.3 | 10.0 | 8.7 | 10.7 |

### Example 2: Free Fatty Acid Release from Lipids Upon Exposure to Native Patatin

In order to assess the stability of different lipids in the presence of patatin, a series of emulsions was prepared from 33 gram per liter demiwater solutions of patatin and an equal amount by weight of lipid. Fats were melted before use, oils were used as is.

TABLE 2
Free fatty acid formation of different lipids upon incubation with

| | | | mmol | |
|---|---|---|---|---|
| | | Incubation | FFA/kg | |
| Substrate | Patatin/blank | temperature | oil | pAv |
| Coconut oil | Blank | 20° C. | 2 | 0.13 |
| Coconut oil | patatin | 20° C. | 51 | 0.15 |
| Coconut oil | patatin | 40° C. | 89 | 0.76 |
| Corn oil | Blank | 20° C. | 2 | 0.13 |
| Corn oil | patatin | 20° C. | 31 | 0.26 |
| Vegetable fat A | Blank | 20° C. | 3 | 0.39 |
| Vegetable fat A | patatin | 20° C. | 43 | 0.40 |
| Vegetable fat B | Blank | 20° C. | 2 | 0.23 |
| Vegetable fat B | patatin | 20° C. | 53 | 0.39 |
| Grapeseed oil | patatin | 40° C. | 16 | 1.04 |
| Olive oil | Blank | 20° C. | 4 | 1.28 |
| Olive oil | patatin | 20° C. | 12 | |
| Olive oil | patatin | 40° C. | 22 | 1.12 |
| Palm stearin | Blank | 20° C. | 8 | 2.16 |
| Palm stearin | patatin | 20° C. | 38 | 2.41 |
| Palm stearin | patatin | 40° C. | 104 | 6.68 |
| Peanut oil | patatin | 40° C. | 16 | 0.68 |
| Rapeseed oil | patatin | 40° C. | 11 | 0.56 |
| Red palm oil | patatin | 40° C. | 277 | 5.11 |
| Rice oil | Blank | 20° C. | 12 | |
| Rice oil | patatin | 40° C. | 41 | 1.00 |
| Sesame oil | patatin | 40° C. | 12 | 0.82 |
| Shea butter | Blank | 20° C. | 2 | |
| Shea butter | patatin | 20° C. | 28 | |
| Soybean oil | Blank | 20° C. | 2 | 0.23 |
| Soybean oil | patatin | 20° C. | 38 | 0.44 |
| Sunflower oil | Blank | 20° C. | 2 | 0.54 |
| Sunflower oil | patatin | 20° C. | 7 | |
| Sunflower oil | patatin | 40° C. | 15 | 0.65 |

The lipid and water were emulsified by means of an ultraturrax (T18 Ultraturrax with T18N dispersing tool) operating at 10 krpm for 1 minute and these emulsions were incubated at either ambient temperature (20° C.±0.2° C.) or at 40° C. for one day under mild agitation. Blanks were measured at room temperature.

The free fatty acid content of the oils was then determined by titration as described; The pAV was also determined. The results are provided in table 2.

The results in table 2 show that in all cases a higher incubation temperature results in a higher free fatty acid content, which serves as an accelerated test to establish free fatty acid development in a meat substitute. Furthermore, this shows that in food products in general, a higher preparation temperature results in faster free fatty acid development. A high free fatty acid content may cause off-taste, for example by the presence of free fatty acids or by further oxidation of free fatty acids.

### Example 3: Off-Flavor Formation in Patatin-Containing Emulsions Prepared with Various Lipids

Emulsions were prepared from a 10 wt. % solution of patatin in water, by emulsification of the lipid in a patatin solution:lipid wt. ratio of 1:2. The emulsions are tested for off-flavor formation by sensoric testing by a panel of trained sensoric testers. The tests were performed immediately after preparation, and after two days of storage at room temperature, mimicking an accelerated cool storage period. The results are shown in table 3. The results show that lipids with the fatty acid content specified in the text do not result off-flavor immediately after preparation, and are stable to storage. Lipids not in line with this definition result in serious off-flavors immediately after preparation, which even gets worse upon storage.

TABLE 3
results of sensory tests on patatin-lipid emulsions

| | Off flavor after | Of flavor after |
|---|---|---|
| Lipid | preparation* | storage* |
| Sunflower oil | − | − |
| Olive oil | − | − |
| Rapeseed oil | − | − |
| Rapeseed oil - hydrogenated | − | − |
| Corn oil | − | − |
| Soybean oil | − | − |
| Rice oil | − | − |
| Sesame oil | − | − |
| Peanut oil | − | − |
| Grapeseed oil | − | − |
| Vegetable fat A | − | − |
| Vegetable fat B | − | − |
| Coconut oil | ++ | +++ |
| Palm kernel oil | + | + |
| Red palm oil | + | + |

*− not detected; + detected; ++ medium off flavor; +++ very strong off flavor

Based on the results of examples 2 and 3 combined, it can be concluded that off-taste does not develop provided that the pAV is maintained at 2 or less, preferably 1.5 or less, even more preferably 1 or less. In addition, it can be concluded that off-taste does not develop provided that the release of free fatty acids is generally less than 50 mmol/kg oil, preferably less than 40 mmol./kg oil.

### Example 4: Off-Flavor Formation in Patatin-Bound Meat Substitutes Prepared with Various Lipids

A series of raw-type meat substitutes was prepared using various lipids. The meat substitute was prepared according to the standardized recipe shown below, following a standardized procedure.

The textured plant protein was hydrated and subsequently mixed with the dry ingredients and the sunflower oil in a Hobart mixing machine. A further portion of the variable lipid was introduced (melted where necessary), and further mixed to obtain a homogenous mixture. The mixture was shaped into a burger patty and allowed to solidify.

| Ingredient | Mass % |
|---|---|
| Soy TVP | 21.0 |
| Water | 56.0 |
| Variable lipid | 8.0 |
| Sunflower oil | 3.0 |
| Solanic 200 | 5.0 |
| Potato starch | 3.0 |
| Potato fiber | 2.5 |
| Sodium salt | 1.0 |
| Dextrose | 0.5 |
| Total | 100.0 |

Off flavor formation was evaluated by sensoric testing by a panel of trained sensoric testers immediately after preparation, and after two days of storage at room temperature. These conditions mimic an accelerated cool storage period. The results are shown in table 4.

TABLE 4
off-flavor formation in meat substitutes
prepared with various lipids.

| | Off flavor after | Off flavor after |
|---|---|---|
| Variable lipid | preparation* | storage* |
| Sunflower oil | − | − |
| Olive oil | − | − |
| Rapeseed oil | − | − |
| Rapeseed oil - hydrogenated | − | − |
| Corn oil | − | − |
| Soybean oil | − | − |
| Rice oil | − | − |
| Sesame oil | − | − |
| Peanut oil | − | − |
| Grapeseed oil | − | − |
| Vegetable fat A | − | − |
| Vegetable fat B | − | − |
| Coconut oil | +++ | +++ |
| Palm kernel oil | + | ++ |
| Red palm oil | + | ++ |

*− not detected; +detected; ++ medium off flavor; +++ very strong off flavor

The results show that in meat substitutes which apply native patatin as a binder, lipids as specified herein suppress off-flavor formation.

### Example 5: Off-Flavor Formation in Bakery Products Prepared from Native Patatin in Combination with Various Lipids

As a model bakery product, vegan muffins were prepared. The same method may however be adapted using common general knowledge on the preparation of other bakery products, preferably vegan bakery products, in order to obtain bakery products such as a cookie, cake, pie, macaron, sponge cake, or waffle.

Vegan (egg-free) muffins were prepared by preparing a batter as a mixture comprising water, native patatin and various lipids.

Native patatin was introduced in the batter as pure native patatin (Solanic 200 (“S200”), commercially available from Avebe), or as a native potato protein mixture comprising a roughly 1:1 ratio of native patatin and native potato protease inhibitor (“PR mix”). The lipids used were sunflower oil (“SF”), a lipid according to the invention, and coconut oil (“Coco”), as a reference lipid.

The muffins were prepared on the basis of the following ingredients:

| | SF-S200 | SF-PR | Coco-S200 | Coco-PR- |
|---|---|---|---|---|
| Ingredient | (%) | mix (%) | (%) | mix (%) |
| Solanic 200 | 1.6 | / | 1.6 | / |
| PR-mix | / | 1.6 | / | 1.6 |
| Water | 23.8 | 23.8 | 23.8 | 23.8 |
| Coconut oil | / | / | 25.3 | 25.3 |
| Sunflower oil | 25.3 | 25.3 | / | / |
| wheat flour | 25.3 | 25.3 | 25.3 | 25.3 |
| Sugar | 22.8 | 22.8 | 22.8 | 22.8 |
| Emul 16 (emulsifier | 0.5 | 0.5 | 0.5 | 0.5 |
| from Breatec) | | | | |
| SAPP28 (Disodium | 0.3 | 0.3 | 0.3 | 0.3 |
| diphosphate from | | | | |
| Budenheim) | | | | |
| Sodium bicarbonate | 0.2 | 0.2 | 0.2 | 0.2 |
| Salt (NaCl) | 0.2 | 0.2 | 0.2 | 0.2 |
| Total | 100.0 | 100.0 | 100.0 | 100.0 |

The muffins were prepared by mixing the dry ingredients into a homogenous mixture at room temperature (20° C.), adding the lipid and the water to the dry mixture, and mixing this for two minutes into a batter with a smooth and silky appearance.

The batter was introduced into paper cups in portions of about 50 ml. The total time in which the native patatin was in contact with the lipid at room temperature was about ten minutes.

The paper cups with batter were subsequently baked for 33 minutes in an oven (Probat) at a temperature of 195° C. in the upper part and 185° C. in the bottom part, with an open valve for the last 5 minutes.

In line with common general knowledge on the preparation of bakery products, the heating temperature is the outside (oven) temperature; the core temperature of the bakery product will gradually rise during the baking period to about 95° C., at which point the bakery product is ready. This leaves a significant period in which the lipid is in contact with native patatin at increased temperature, which period is associated with accelerated off-flavor formation, prior to the denaturation of patatin at the highest temperatures.

The sensory characteristics of the batter after preparation and of the muffin after baking were evaluated by a panel of trained experts in line with general practice in the food industry.

TABLE 5
off-flavor formation in bakery products

| Ingredient | SF-S200 | SF-PRmix | Coco-S200 | Coco-Prmix |
|---|---|---|---|---|
| After mixing | − | − | ++ | + |
| After baked | − | − | +++ | ++ |

*The intensity of the detected off-smell is ranked from “+” (low intensity) to “+++++” (very strong intensity); “−“: means not detectable.

The results show that both the batters (before baking) as well as the muffins (after baking) comprising patatin and coconut oil have off-flavors, while the batters comprising patatin and the lipid of the invention, as well as muffins prepared therefrom, do not have off-flavors. Patatin in combination with a lipid as specified in the text do not result in any off-taste in bakery product, not in the batter, nor after baking. In addition, the results confirm that off-flavors develop in an accelerated fashion by creating a situation in which native patatin is in contact with those lipids not according to the invention at an increased temperature. This can be avoided by applying a lipid of the invention, thereby preventing off-flavor formation.

### Example 6: Off-Flavor Reduction in Vegan Egg Products (Plant-Based Egg

Vegan egg products were prepared on the basis of the below ingredients:

| | Recipe 1 | Recipe 2 |
|---|---|---|
| Ingredient | % (asis) | % (asis) |
| Solanic 200 | 5 | 4 |
| Soy protein isolate | 10 | |
| Pumpkin seed protein | | 10 |
| Corn starch | 5 | 4 |
| Lipid | 10 | 10 |
| Salt | 1 | 1 |
| Egg flavour | As desired | As desired |
| Water | 69 | 71 |

Soy protein isolate: ADM; Corn starch: Cargill B. V.; Egg flavour: 24 Mantra; Pumpkin seed protein was obtained from commercial pumpkin seeds, obtained from a local supermarket. The seeds were soaked in potable water for 2 h at ambient temperature. After peeling off the skins, the seeds were subjected to milling in a blender. Skins were discarded. After milling the material was pressed through a cheesecloth (150 μm mesh) to obtain a soluble protein solution. The solution was then subjected to fat extraction using pentane (5:1 (v/v) ratio, respectively) for 2 h at ambient temperature 5 while mixing. After centrifugation of the mixture at 4.000 g. the organic phase (holding the fats) was removed by decantation. The aqueous phase was combined with the obtained pellet and homogenized.

The pH of the aqueous protein mixture was adjusted to pH 8.5 using 1 M NaOH. The proteins were homogenized using short mixing and freeze-dried to reach a moisture content less than 10%.

### Preparation and Results

The indicated protein, corn starch, egg flavor and salt were dry mixed to a homogenous powder mixture. Subsequently, lipid oil and water were added to the powder mixture, and the total mixture was well mixed in a Hobart mixer to obtain vegan raw egg batter in the form of an emulsion. The batters were stored cool (4° C.) for two days.

The batter was fried in a cooking pan until egg-like gelation occurred, and until golden brown. Frying was done similar to preparing “scrambled eggs”.

The nature of the lipid was varied, and off-flavor formation was determined by sensory evaluation.

TABLE 6
off-flavor formation in egg substitutes prepared with various lipids.

| Variable lipid | Off flavor after cold storage* |
|---|---|
| Sunflower oil | − |
| Corn oil | − |
| Coconut oil | +++ |

*− not detected; + detected; ++ medium off flavor; +++ very strong off flavor

The results show that in egg substitutes prepared with native patatin and a lipid of the invention, off flavor formation is suppressed.

### Example 7: Off-Flavor Reduction in Sauces

As a model sauce, a plant-based (vegan) mayonnaise was prepared on the basis of the below ingredients.

The mayonnaise was prepared by introducing the cold water and the mustard into a kitchen blender. Native patatin (Solanic 200), maltodextrin, salt, sugar, preservative (potassium sorbate) are added, and mixed with the water and mustard to obtain a homogenous dispersion. Lipid is added slowly while mixing at high intensity, in order to obtain a stable emulsion, without “breaking” the emulsion. When about ⅔ of the lipid has been added, vinegar and lemon juice are mixed in, prior to slowly adding the remaining oil and homogenizing to obtain a smooth and creamy white vegan mayonnaise. The mayonnaise is filled into sealable containers and stored cool (4° C.) for several days.

| | % | g | % | g |
|---|---|---|---|---|
| Water | 57.8 | 433.5 | 21.5 | 161.3 |
| Eliane SC160 | 4.5 | 33.8 | 0 | 0 |
| Solanic 200 | 1 | 7.5 | 1 | 7.5 |
| Avebe MD20 | 0.1 | 0.75 | 0.1 | 0.75 |
| Dijon mustard | 2 | 15 | 2 | 15 |
| sugar | 3.5 | 26.3 | 3.5 | 26.3 |
| salt | 1 | 7.5 | 1 | 7.5 |
| potassium sorbate | 0.1 | 0.75 | 0.1 | 0.75 |
| sunflower oil | 25 | 187.5 | 65 | 487.5 |
| vinegar 5% | 5 | 37.5 | 3 | 22.5 |
| lemon juice | | | 2.8 | 21 |
| Total | 100 | 750 | 100 | 750 |

The nature of the lipid was varied, and off-flavor reduction was evaluated by sensory evaluation after three days.

TABLE 7
off-flavor formation in mayonnaise prepared with various lipids.

| Variable lipid | Off flavor after cold storage* |
|---|---|
| Sunflower oil | − |
| Corn oil | − |
| Coconut oil | +++ |

*−not detected; + detected; ++ medium off flavor; +++ very strong off flavor

The results show that in mayonnaise prepared with native patatin and a lipid of the invention, off flavor formation is suppressed.

1. A method for making a food product other than a meat substitute, comprising
a) providing a mixture comprising water, native patatin and a lipid, which lipid is defined as a substance comprising fatty acid tri-esters of glycerol, wherein the fatty acids in said lipid comprise less than 2% by mass of fatty acids having a chain length of C12 or less, and wherein the quantity of lipid relative to native patatin, expressed as the weight ratio of lipid to native patatin, is 90:1 or less;
b) making the food product.

2. The method according to claim 1, wherein the fatty acids in said lipid comprise less than 2% by mass of fatty acids having a chain length of C14 or less.

3. The method according to claim 1, wherein at least 98% by mass of the fatty acids in said lipid are fatty acids having a chain length of C12 or higher.

4. The method according to 1, wherein the lipid comprises one or more of the lipids in the group of corn oil, soybean oil, rapeseed oil, sunflower oil, grape seed oil, peanut oil, sesame oil, olive oil, shea butter, cocoa butter, and rice bran oil, which lipids may optionally have been hydrogenated.

5. The method according to 1, wherein the lipid provided to the mixture comprises less than 18 mmol per kg lipid of free fatty acids, and/or wherein the total of diacylglycerols and monoacylglycerols, relative to the total lipid, is less than 10 wt. %.

6. The method according to 1, wherein making the food product comprises one or more of the steps of shaping, mixing, cooling, heating, fermentation, combination with further ingredients and/or a period of storage.

7. The method according to 1, wherein the food product is selected from a batter, dough, bakery product, cheese, cream cheese, butter, yoghurt, sauce, dressing, cream, vegan egg product or a fried snack.

8. The method according to 1, wherein the food product is a vegan food product, defined as a food product which does not comprise animal-derived ingredients.

9. The method according to 1, wherein making the food product comprises a step of heating the food product to a temperature of at least 75° C., for a period of at least 1 minute.

10. The method according to claim 9, wherein the food product is a bakery product, the method comprising
a) providing a mixture comprising water, flour, native patatin and the lipid;
b) homogenizing and optionally ripening the mixture; and
c) heating the mixture to a temperature of at least 125° C. for a period of at least 15 minutes.

11. The method according to claim 9, wherein the mixture further comprises one or more of a sugar, artificial sweetener, emulsifier, yeast, leavening agent, colorant, flavoring, and/or further optional ingredients.

12. The method according to claim 1, wherein making the food product comprises a step of cooling to a temperature of from −35° C. to 20° C.

13. The method according to claim 1, wherein the food product is a sauce, said method comprising providing a mixture comprising water, lipid, native patatin and optional further ingredients, and homogenizing said mixture to obtain the sauce.

14. The method according to claim 1, wherein the food product is an emulsified sauce, said method comprising providing a mixture comprising water, native patatin and optional further ingredients, homogenizing said mixture, and adding lipid while mixing so as to obtain a stable emulsion.

15. The method according to claim 1, wherein the food product is a vegan egg product, said method comprising providing a mixture comprising water, native patatin, the lipid and optional further ingredients, homogenizing and optionally aerating said mixture to obtain a batter, and heating said batter to a temperature of at least 75° C. for at least one minute.

16. The method according to claim 15, where the vegan egg product comprises one or more of
one or more proteins derived from tuber, cereal, nut or legume,
one or more starches derived from tuber, cereal or legume,
one or more salts;
one or more additives;
one or more of a fruit, vegetable, nut or tuber.

17. A food product obtainable by the method of claim 1.

18. A food product other than a meat substitute prepared from water, native patatin, and a lipid, which lipid is defined as a substance comprising fatty acid tri-esters of glycerol, wherein the fatty acids in said lipid comprise less than 2% by mass of fatty acids having a chain length of C12 or less, and wherein the quantity of lipid relative to patatin, expressed as the weight ratio of lipid to patatin, is 90:1 or less.

19. The food product according to claim 18, which food product is a vegan food product, defined as a food product not comprising animal-derived ingredients.

20. The food product according to claim 18, which food product is a batter, dough, butter, cheese, cream cheese, yoghurt, sauce, dressing, vegan egg product or cream.

21. The food product according to claim 18, which food product has not been heated to a temperature above 60° C., comprising water, native patatin and the lipid.

22. The food product according to claim 18, which food product is a bakery product prepared from water, native patatin, flour and the lipid.

23. The bakery product according to claim 22 wherein the bakery product further comprises one or more of a sugar, artificial sweetener, emulsifier, yeast, leavening agent, colorant, flavoring, and/or further optional ingredients.

24. The bakery product according to claim 22, which bakery product is selected from a muffin, cookie, cake, pie, macaron, sponge cake, or waffle.

25. A batter or dough for preparing a bakery product, comprising from 10-40 wt. % water, 15-35 wt. % flour, 15-35 wt. % lipid, which lipid is defined as a substance comprising fatty acid tri-esters of glycerol, and 0.1-25 wt. % native patatin, wherein the fatty acids in said lipid comprise less than 2% by mass of fatty acids having a chain length of C12 or less, and wherein the quantity of lipid relative to patatin, expressed as the weight ratio of lipid to patatin, is 90:1 or less.

26. A food product according to claim 18, said food product being a sauce, which sauce comprises, as wt. % of the total weight of the sauce,
15-65 wt. % water
0.25-5 wt. % native patatin
15-85 wt. % lipid.

27. The sauce according to claim 26, which sauce is a full-fat sauce comprising 15-30 wt. % water, 0.25-5 wt. % native patatin and 50-85 wt. % lipid, or which sauce is a low-fat (“light”) sauce comprising 30-65 wt. %, of water, 0.25-5 wt. %, of patatin, 15-35 wt. % lipid, and 1-10 wt. % of cold-water soluble stabilized and crosslinked starch.

28. The sauce according to claim 27, further comprising, as wt. % of the total weight of the sauce, one or more optional ingredients selected from the group of taste active agents, stabilizers and texturizers.

29. The food product according to claim 18, which food product is a vegan egg product, said vegan egg product being prepared from, as wt. % of the vegan egg product,
55-85 wt. % of water; and
3-15 wt. % of lipid; and
1-15 wt. % native patatin.

30. A batter for preparing a vegan egg product, comprising
55-85 wt. % of water; and
3-15 wt. % of lipid, which lipid is defined as a substance comprising fatty acid tri-esters of glycerol; and
1-15 wt. % native patatin;
wherein the fatty acids in said lipid comprise less than 2% by mass of fatty acids having a chain length of C12 or less, and wherein the quantity of lipid relative to patatin, expressed as the weight ratio of lipid to patatin, is 90:1 or less.

31. The vegan egg product according to claim 29, further comprising at least one of
one or more proteins derived from tuber, cereal, nut or legume,
one or more starches derived from tuber, cereal or legume;
one or more salts;
one or more additives;
one or more of a fruit, vegetable, nut or tuber.
Please add new claims 32-45 as follows:

32. The method according to claim 1, wherein at least 98% by mass of the fatty acids in said lipid are fatty acids having a chain length of C14 or higher.

33. The method according to claim 6, wherein the period of storage comprises cold storage at a temperature of less than 10° C.

34. The method according to claim 1, wherein making the food product comprises a step of heating the food product to a temperature of at least 125° C., for a period of at least 1 minute.

35. The method according to claim 1, wherein making the food product comprises a step of heating the food product to a temperature of at least 75° C., for a period of at least 15 minutes.

36. The method according to claim 1, wherein making the food product comprises a step of heating the food product to a temperature of at least 125° C., for a period of at least 15 minutes.

37. The method according to claim 15, where the vegan egg product comprises, as optional further ingredients, one or more of
one or more proteins selected from soy protein, pea protein, wheat protein/gluten, potato protein, faba bean protein, mungbean protein, hemp seed protein, mushroom protein, sesame seed protein, sweet potato protein, chick pea protein, lentil protein, oat protein, spelt protein, and pumpkin seed protein;
one or more starches selected from potato starch, tapioca, rice starch, corn starch, wheat starch and pea starch;
one or more salts selected from sodium chloride and potassium chloride;
one or more additives selected from flavorings, colorings and texturisers
one or more of a fruit, vegetable, nut or tuber.

38. A food product other than a meat substitute according to claim 18, wherein the fatty acids comprise less than 2% by mass of fatty acids having a chain length of C14 or less.

39. The sauce according to claim 27, which sauce is a low-fat (“light”) sauce comprising 50-65 wt. %, of water, 0.5-2.5 wt. %, of patatin, 20-30 wt. %, of lipid, and 2-8 wt. % of cold-water soluble stabilized and crosslinked starch.

40. The sauce according to claim 28, further comprising, as wt. % of the total weight of the sauce, pone or more optional ingredients selected from one or more taste active agents selected from vinegar, mustard, sugar, salt, herbs and/or spices; a potassium sorbate stabilizer, a texturizer selected from regular or modified starch, hydrocolloid, maltodextrin, which one or more optional ingredients are present in a quantity of 0.1-5 wt. % per ingredient.

41. The vegan egg product according to claim 29, which vegan egg product is being prepared from, as wt. % of the vegan egg product,
60-75 wt. % of water; and
5-15 wt. % of lipid; and
2-10 wt. % native patatin.

42. The batter according to claim 30, comprising
60-75 wt. % of water; and
5-15 wt. % of lipid; and
2-10 wt. % native patatin.

43. The vegan egg product according to claim 29 further comprising at least one of
one or more proteins selected from soy protein, pea protein, wheat protein/gluten, potato protein, faba bean protein, mungbean protein, hemp seed protein, mushroom protein, sesame seed protein, sweet potato protein, chick pea protein, lentil protein, oat protein, spelt protein and pumpkin seed protein;
one or more starches selected from potato starch, tapioca, rice starch, corn starch, wheat starch and pea starch;
one or more salts selected from sodium chloride and potassium chloride;
one or more additives selected from flavorings, colorings and texturisers;
one or more of a fruit, vegetable, nut or tuber.

44. The batter for a vegan egg product according to claim 30, further comprising at least one of
one or more proteins derived from tuber, cereal, nut or legume;
one or more starches derived from tuber, cereal or legume;
one or more salts;
one or more additives;
one or more of a fruit, vegetable, nut or tuber.

45. The batter for a vegan egg product according to claim 30, further comprising at least one of
one or more proteins selected from soy protein, pea protein, wheat protein/gluten, potato protein, faba bean protein, mungbean protein, hemp seed protein, mushroom protein, sesame seed protein, sweet potato protein, chick pea protein, lentil protein, oat protein, spelt protein and pumpkin seed protein;
one or more starches selected from potato starch, tapioca, rice starch, corn starch, wheat starch and pea starch;
one or more salts selected from sodium chloride and potassium chloride;
one or more additives selected from flavorings, colorings and texturisers;
one or more of a fruit, vegetable, nut or tuber.
